(19) United States
(12) Patent Application Publication
(10) Pub. No.: US 2023/0411701 A1
(43) Pub. Date: Dec. 21, 2023

(54) ELECTROCHEMICAL CELL

(71) Applicant: Dyson Technology Limited, Wiltshire (GB)

(72) Inventors: Robert Ian Joseph GRUAR, Swindon (GB); Neil Ross SIM, Swindon (GB)

(73) Assignee: Dyson Technology Limited, Wiltshire (GB)

(21) Appl. No.: 18/035,569

(22) PCT Filed: Oct. 12, 2021
(86) PCT No.: PCT/GB2021/052628

§ 371 Date: May 5, 2023

(30) Foreign Application Priority Data
Nov. 26, 2020 (GB) 2018642.5

(51) Int. Cl. H01M 10/0585; H01M 10/056; H01M 10/0525; H01M 4/04; H01M 4/38; H01M 50/207

(52) U.S. Cl. CPC H01M 10/0585; H01M 10/056; H01M 10/0525; H01M 4/0404; H01M 4/0435; H01M 4/382; H01M 50/207; H01M 2300/0082; H01M 2300/0085; H01M 2300/0094; H01M 2300/0068

(57) ABSTRACT

Described herein is a laminate electrochemical cell including a cathode layer, an anode layer, a polymer electrolyte layer, and a ceramic layer. The polymer electrode layer is arranged between the cathode layer and the anode layer and coats at least a portion of the anode layer. The ceramic layer is arranged between the polymer electrolyte layer and the cathode layer. The ceramic layer and the polymer electrolyte layer have different compositions. Also described herein are methods of manufacturing the laminate electrochemical cell, battery stacks including a plurality of said laminate electrochemical cells, and electrically-powered devices including the electrochemical cell or battery stack.

### TECHNICAL FIELD

The present invention relates to electrochemical cells, methods of manufacturing electrochemical cells, battery stacks comprising a plurality of laminate electrochemical cells, and electronic devices comprising electrochemical cells.

### BACKGROUND

Electrochemical cells typically comprise liquid electrolyte. Examples of electrochemical cells comprising liquid electrolyte include lithium-ion batteries. There are safety concerns regarding lithium-ion batteries because they are prone to thermal runaway. Given that the liquid electrolyte contained in the lithium-ion is flammable, there is a risk that such lithium-ion batteries may explode. Electrochemical cells comprising liquid electrolyte may also be prone to leakage. Moreover, while lithium-ion batteries are considered to be relatively efficient, there is a consumer demand for electrochemical cells having higher energy density.

Solid-state electrochemical cells have been developed which do not include liquid electrolyte. Higher energy densities can be achieved with some solid-state cells than with typical liquid-electrolyte-containing electrochemical cells. However, high material costs are associated with solid-state cells. Further, new manufacturing equipment and processes may be required to manufacture a solid-state cell. The expenditure associated with such new equipment and processes may deter electrochemical cell manufacturers from developing solid-state cells. For these reasons (among others), there has been limited mainstream adoption of solid-state electrochemical cell technology.

### SUMMARY

In examples of a first aspect of the present disclosure, there is provided a laminate electrochemical cell comprising:
a cathode layer;
an anode layer;
a polymer electrolyte layer arranged between the cathode layer and the anode layer, the polymer electrolyte layer coating at least a portion of the anode layer; and
a ceramic layer arranged between the polymer electrolyte layer and the cathode layer;
wherein the ceramic layer and the polymer electrolyte layer have different compositions.

The present inventors have identified that such a laminate electrochemical cell can be manufactured using standard manufacturing equipment and processes. Further, by providing a combination of a ceramic layer and a polymer electrolyte layer, the risk of thermal runaway is reduced compared with conventional electrochemical cells which comprise liquid electrolyte. Thus, the electrochemical cells of the present disclosure may be less prone to explosion and have a higher energy density than conventional lithium-ion batteries.

The cathode may comprise any material suitable for use in a cathode of an electrochemical cell. In examples, the cathode comprises material typically employed in cathodes of solid-state batteries. The cathode typically comprises material comprising one or more lithium species such as lithium-based oxides or lithium-based phosphates. In examples, the cathode comprises: lithium cobalt oxide (LiCoO₂), typically referred to as LCO; lithium manganese oxide (LiMn₂O₄), typically referred to as LMO; lithium nickel manganese cobalt oxide (LiNi_{1-x-y}MnₓCo_{y}O₂), typically referred to as NMC; lithium iron phosphate (LiFePO₄), typically referred to as LFP, lithium nickel cobalt aluminium oxide (LiNi_{1-x-y}CoₓAl_{y}O₂), typically referred to as NCA; lithium sulfide (Li₂S); silver vanadium oxide (AgV₂O_{5.5}), typically referred to as SVO; and combinations thereof (e.g. the cathode may comprise a composite of any of the materials described herein). In examples, the cathode comprises amorphous material (e.g. the cathode has an amorphous structure). In examples, the cathode comprises crystalline material (e.g. the cathode has a crystalline structure).

In examples, the cathode comprises composite cathode material. The composite cathode material comprises gel polymer electrolyte and particles of any of the cathode materials described hereinabove arranged in the gel polymer electrolyte. The particles of cathode material are typically homogeneously dispersed through the gel polymer electrolyte of the composite cathode material. The particles of cathode material typically constitute on a dry weight basis at least 50 wt % of the composite cathode material. In examples, the particles of cathode material constitute on a dry weight basis at least 60 wt %, 70 wt %, 80 wt %, or 85 wt % of the composite cathode material.

The inventors have identified that a cathode comprising composite cathode material as described herein typically provides improved interfacial contact between the cathode and the abutting layer of the electrochemical cell due to the increased deformability of the cathode.

For the avoidance of doubt, the cathode comprising composite cathode material is distinct from the polymer electrolyte layer of the laminate electrochemical cell. The polymer electrolyte layer essentially does not comprise particles of cathode material (e.g. the polymer electrolyte layer does not comprise cathode material in an amount for the polymer electrolyte layer to effectively function as a cathode).

Typically, the cathode layer has a first surface facing the ceramic layer and a second surface opposite the first surface, a current collector being disposed on the second surface cathode layer. As described hereinbelow, examples of manufacturing the electrochemical cell include depositing material on a current collector to provide a cathode layer on the current collector.

The current collector is typically a metal foil (e.g. copper, nickel, stainless steel), metal screen, metal film on a polymer film or sufficiently conductive SiO₂ layer, or any other known substrate or barrier layer. In examples, the current collector is configured to form an electrode on both faces of the layer, e.g. for use in a battery stack.

The ceramic layer typically comprises ceramic electrolyte material. In examples, the ceramic layer is a crystalline lithium-ion (‘Li-ion’) ceramic. In examples, the ceramic layer is an amorphous/glass ceramic. The ceramic layer typically functions as a separator between the cathode and the anode, preventing the anode and cathode from coming into direct contact and thereby short-circuiting the cell.

The ceramic layer typically comprises, consists essentially of, or consists of: perovskite-type Li-ion conductor; anti-perovskite-type Li-ion conductor; garnet-type Li-ion conductor; sodium super ionic Li-ion conductor (NASICON); NASICON-related Li-ion conductor; lithium super ionic conductor (LISICON); LISICON-related Li-ion conductor; thio-LISICON; thio-LISICON-related Li-ion conductor; lithium phosphorous oxy-nitride (LiPON); related amorphous glassy type Li-ion conductors, or combinations thereof (e.g. the ceramic layer may comprise a composite of any of the materials described herein). In a particular embodiment, the ceramic layer comprises lithium phosphorous oxy-nitride (LiPON), the LiPON having the following formula: LiₓPO_{y}N_{z} where x=2y+3z−5, and x<4. In examples, the ceramic layer comprises at least 50 wt %, 80 wt %, 90 wt %, 95 wt % or 99 wt % LiPON by dry weight of the ceramic layer. In examples where the ceramic layer comprises LiPON, the ceramic layer is typically referred to as ‘the LiPON layer’.

The ceramic layer is arranged between the cathode layer and the polymer electrolyte layer. In examples, the ceramic layer abuts (is in contact with) the cathode layer and/or the polymer electrolyte layer. In examples, the ceramic layer coats at least 80%, 90%, or substantially all of the first surface of the cathode layer. In examples, the ceramic layer is a LiPON layer and coats at least 80%, 90%, or substantially all of the first surface of the cathode layer.

In some examples, the ceramic layer abuts neither the anode nor the cathode. In these examples, a further polymer electrolyte layer may be arranged between the ceramic layer and the cathode layer. The further polymer electrolyte layer has any composition described herein in relation to the polymer electrolyte layer. Where a further polymer electrolyte layer is present, the further polymer electrolyte typically has the same composition as the polymer electrolyte layer of the laminate electrochemical cell.

The ceramic layer does not abut (is not in contact with) the anode layer. A ceramic layer, such as a LiPON layer, juxtaposed with an anode layer (i.e. in direct contact) may degrade if the anode material is particularly reactive. In contrast, according to the electrochemical cells of the present disclosure, by providing a layer between the ceramic layer and the anode, the ceramic layer is less prone to degradation, meaning that more reactive anode materials can be employed.

Further, the inventors have identified that, because of its more brittle structure, a ceramic layer can be susceptible to damage over charge/discharge cycles due to variations in the volume of components of the electrochemical cell (e.g. expansion and contraction). The expansion/contraction of the cathode layer has been identified to be less than that of the anode layer during charge/discharge cycles, so it is advantageous to arrange the ceramic layer on the cathode layer rather than the anode layer.

Further still, the present inventors have identified that, surprisingly, an electrochemical cell comprising only one ceramic layer disposed on the cathode provides performance which is comparable with an electrochemical cell comprising a ceramic layer coating the cathode as well as a ceramic layer coating the anode (referred to herein as a “double coated cell”). Accordingly, the electrochemical cell described herein may be simpler and more cost-effective to manufacture than a double coated cell while still providing satisfactory performance.

In some examples, the ceramic layer is porous. For example, the ceramic layer has a series of pores extending through the entire thickness of the ceramic layer. In these examples, the ceramic layer may be referred to as a ceramic mesh. The ceramic layer being porous may allow deformable electrolyte material to extend through the ceramic layer. Electrolyte material extending through the ceramic layer thus may increase conductivity in the cell. In particular, electrolyte material extending through the ceramic layer may enhance the Li-ion transport number (also referred to as the transference number). Further, the inventors have identified that, in examples, filling pores of the brittle ceramic layer with polymer electrolyte improves the stability of the ceramic layer, whilst also allowing for expansion and contraction of the polymer electrolyte. Moreover, a porous ceramic layer may have a lower mass than a corresponding non-porous ceramic layer, thereby reducing the mass of the cell and thus increasing the energy density of the cell. In examples, the ceramic layer is porous, and the polymer electrolyte layer comprises gel polymer electrolyte (discussed hereinbelow).

In some examples the ceramic layer abuts neither the anode nor the cathode, and is arranged between the polymer electrolyte layer and a further polymer electrolyte layer. Where the ceramic layer is porous and both the polymer electrolyte layer and further polymer electrolyte layer comprise gel polymer electrolyte, the polymer electrolyte layer contacts the further polymer electrolyte layer through the pores of the porous ceramic layer.

In other examples, the ceramic layer is not porous. In examples, the ceramic layer does not comprise polymer (e.g. is distinct from the polymer electrolyte layers; the layers are discrete).

In examples, the ceramic layer comprises a homogenous material. The homogenous material comprises ceramic, and does not comprise polymer electrolyte. Although in some examples the polymer electrolyte of the polymer electrolyte layer may extend through portions of the ceramic layer (e.g. where the ceramic layer is porous and the polymer electrolyte layer comprises gel polymer electrolyte), in these examples, because the homogenous material comprised in the ceramic layer does not itself comprise polymer electrolyte, the ceramic layer is said to not comprise polymer electrolyte.

In examples, the polymer electrolyte layer does not comprise ceramic (e.g. the ceramic layer is distinct from the polymer electrolyte layer; the layers are discrete). In examples, the polymer electrolyte layer is a homogenous material, wherein the homogenous material does not comprise ceramic.

The polymer electrolyte layer is arranged between the cathode layer and the anode layer. The polymer electrolyte layer abuts (is in direct contact with) the anode layer; the polymer electrolyte layer coats at least a portion of the anode layer. In examples, the polymer electrolyte layer coats at least 80%, 90%, or substantially all of a first surface of the anode layer. In examples, the polymer electrolyte abuts (is in direct contact with) the ceramic layer.

A polymer electrolyte typically comprises a polymer and a lithium salt.

In examples, the polymer comprises polyethylene oxide (PEO), polypropylene oxide (PPO), polymethylmethacrylate (PMMA) polyacrylonitrile (PAN), and/or polyvinylidene difluoride (PVDF). In examples, the polymer matrix comprises a blend of said polymers. In examples, the polymer matrix comprises one or more copolymers obtainable from said polymers (such as a PAN/PMMA copolymer). In examples, the polymer matrix is crosslinked.

The lithium salt comprises any suitable salt. For example, the lithium salt may comprise LiClO₄, LiBF₄, LIPF₆, LiAsF₆, LiCF₃SO₃, LiN(CF₃SO₂)₂ (LiTFSI), or combinations thereof. In examples, the lithium salt comprises LiO₄Cl, LiTFSI, or combinations thereof.

In some examples, the polymer electrolyte layer comprises solid polymer electrolyte. A polymer electrolyte layer comprising solid polymer electrolyte may be referred to as a solid polymer electrolyte (SPE) layer, a dry solid polymer electrolyte (dry-SPE) layer, or a hard electrolyte layer.

A solid polymer electrolyte typically comprises lithium salt dissolved in a polymer matrix. The polymer matrix may comprise any of the polymers described hereinabove. The lithium salt may comprise any of the lithium salts described hereinabove.

Solid polymer electrolyte layers typically exhibit improved electrochemical stability and thermal stability over conventional Li-ion electrolytes. In examples, the solid polymer electrolyte layer is non-porous.

In other examples, the polymer electrolyte layer comprises gel polymer electrolyte. A polymer electrolyte layer comprising gel polymer electrolyte may be referred to as a gel polymer electrolyte (GPE) layer, or a solvent swollen polymer electrolyte.

A gel polymer electrolyte comprises lithium salt, polymer, and solvent. The solvent acts as a plasticizer, so may also be referred to as a plasticizer. The polymer matrix may comprise any of the polymers described hereinabove. The lithium salt may comprise any of the lithium salts described hereinabove.

The solvent may be any suitable solvent. In examples, the solvent comprises polyethylene glycol (PEG), polyethylene glycol dimethyl ether (PEGDME), dibutyl phthalate (DBP), dimethyl phthalate (DMP), dioctyl phthalate (DOP), succinonitrile (SN), ethylene carbonate (EC), propylene carbonate (PC), diethyl carbonate (DEC), dimethyl carbonate (DMC), 7-butyrolactone (7-BL), or combinations thereof.

Gel polymer electrolyte layers typically exhibit high ionic conductivity. In examples, the gel polymer electrolyte layer comprises inorganic fillers. A gel polymer electrolyte layer comprising inorganic fillers may have improved mechanical properties.

The fluid nature of the gel polymer electrolyte means that it may act as a planarizing layer during manufacture of the cell.

The inventors have identified that, in an electrochemical cell which is entirely solid state (i.e. the entire electrolyte is solid), the anode (e.g. Li metal) may delaminate from the solid electrolyte due to unavoidable morphology changes, resulting in reduction of interfacial contact between the anode and the electrolyte and thus degradation of the cell. In contrast, because the polymer electrolyte layer of the cell in some examples is deformable, the interfacial contact between the anode and the electrolyte layer is less likely to lessen over time. In general, the electrochemical cells in examples described herein may be more resistant to variations in the volume of components of the cell during a charge/discharge cycle.

The ceramic layer and the polymer electrolyte layer have different compositions. For example, the ceramic layer and the polymer electrolyte layer may have one or more components in common, but the proportion of the component(s) which make up the ceramic layer differs from the proportion of the component(s) which make up the polymer electrolyte layer. In examples, at least one of the ceramic layer or the polymer electrolyte layer includes one or more components which is not present in the other layer. In examples, the ceramic layer comprises component(s) not present in the polymer electrolyte layer in an amount of at least 80 wt %, 90 wt %, 95 wt %, or 99 wt % of the ceramic layer (by dry weight). In examples, the polymer electrolyte layer comprises component(s) not present in the polymer electrolyte layer in an amount of at least 80 wt %, 90 wt %, 95 wt %, or 99 wt % of the polymer electrolyte layer (by dry weight). In examples, the ceramic layer and polymer electrolyte layer have no components in common.

The anode may comprise any material suitable for use in an anode of an electrochemical cell. In examples the anode comprises silicon, carbon, indium tin oxide (ITO), molybdenum dioxide (MoO₂), lithium titanate (Li₄Ti₅O₁₂— typically referred to as LTO), lithium alloy, metallic lithium, or combinations thereof. Where the anode comprises carbon, the anode may comprise any suitable carbon-based material. For example, the anode comprises graphite, graphene, hard carbon, activated carbon, and/or carbon black.

In examples, the anode material comprises a lithium-intercalation material. Any of the materials listed hereinabove may be provided as a lithium-intercalated material to the extent that it is technically achievable. For example, the anode comprises lithium-intercalated silicon, lithium-intercalated graphite, or lithium-intercalated graphene. In examples, the anode comprises intercalated silicon or lithium-intercalated graphite.

Typically, the anode layer has a first surface facing the polymer electrolyte layer and a second surface opposite the first surface, a current collector being disposed on the second surface anode layer. As described hereinbelow, examples of manufacturing the electrochemical cell include depositing material on a current collector to provide an anode layer on the current collector.

The current collector is typically a metal foil (e.g. copper, nickel, stainless steel), metal screen, metal film on a polymer film or sufficiently conductive SiO₂ layer, or any other known substrate or barrier layer. In examples, the current collector is configured to form an electrode on both faces of the layer, e.g. for use in a battery stack.

Current collectors typically have a thickness suitable for providing structural support to the layers of the electrochemical cell arranged therebetween. In some examples, e.g. where the current collector is configured to form an electrode on both faces of the layer, the current collector comprises a polymer layer having a first surface and an opposing second surface, a metal layer on the first surface, and a metal layer on the second surface. Surprisingly, the inventors have identified that current collectors according to these examples can be manufactured to be thinner than, for example, current collectors consisting only of metal foil, while providing acceptable performance (e.g. conductivity and/or structural support). The current collectors according to these examples are particularly suitable for use in cells which are provided in a “back-to-back” battery stack, as the reduced thickness of the current collector results in a reduced stack height. In examples, the metal layers arranged on the first and second surfaces of the polymer layer are copper foil layers.

The anode is typically coated on a current collector. For example, the anode may be a Li metal film anode coated on copper foil, or a graphite anode coated on copper foil.

Each of the cathode, ceramic, polymer electrolyte, and anode are provided as layers. A layer may also be referred to as a sheet. A layer extends in a first dimension (length), a second dimension perpendicular to the first dimension (width), and a third dimension perpendicular to both the first and second dimensions (thickness). The thickness is typically the smallest dimension of a layer of an electrochemical cell described herein. Each layer of the electrochemical cell has a thickness. For example, FIG. 1 depicts the cathode 11 having a thickness 11c.

In examples, at least one of the layers present in the electrochemical cell has a thickness greater than or equal to 10 nm, 100 nm, or 1 μm. In examples, at least one of the layers present in the electrochemical cell has a thickness less than or equal to 10 μm. In particular examples, the ceramic layer and polymer electrolyte layer taken together have an aggregate thickness greater than or equal to 1 μm, or 10 μm. Without wishing to be bound by theory, it is believed that the combination of a ceramic layer and polymer electrolyte layer having a given aggregate thickness has a higher conductivity than the electrolyte of a conventional solid-state cell having the same thickness. Thus, the electrochemical cells described herein may comprise one or more layers having a greater thickness than corresponding solid-state cells while maintaining high performance. The ceramic layer and polymer electrolyte layer together having a greater aggregate thickness may allow for a cell having thicker cathode layer(s).

In examples, at least two, three or four of the layers has a thickness greater than or equal to 10 nm, 100 nm, or 1 m. In examples, each layer has a thickness greater than or equal to 0.2 m.

In examples, the laminate electrochemical cell comprises a cathode layer, a ceramic layer abutting the cathode layer, a polymer electrolyte layer abutting the ceramic layer, and an anode layer abutting the polymer electrolyte layer.

Examples of the electrochemical cells described herein include primary cells (e.g. disposable cells) and secondary cells (e.g. rechargeable cells).

In examples of a second aspect of the present disclosure, there is provided a method of manufacturing a laminate electrochemical cell, the method comprising:
providing a cathode layer;
providing a ceramic layer;
providing an anode layer;
depositing a polymer electrolyte on the anode layer and/or the ceramic layer to provide a polymer electrolyte layer; and
combining the cathode layer, ceramic layer, anode layer and polymer electrolyte layer to provide the laminate electrochemical cell such that the ceramic layer is arranged between the cathode layer and the anode layer, and the polymer electrolyte layer is arranged between the ceramic layer and the anode layer.

Said method typically provides an electrochemical cell as described hereinabove. In particular examples, the ceramic layer is a LiPON layer.

The depositing processes carried out in the course of said method may comprise any deposition method suitable for depositing the relevant material on a substrate. In examples, the depositing process comprises vacuum depositing, electroplating, electrophoretic depositing, and/or casting.

In examples, the depositing comprises physical vapour depositing. Physical vapour deposition (PVD) is an example of vacuum deposition and refers to a process wherein a condensed material is vaporised, and then at least some of the vaporised material condenses on a substrate to provide a condensed layer. Examples of PVD include thermal deposition (also referred to as evaporative deposition), and sputtering.

In examples, the depositing comprises chemical vapour depositing. Chemical vapour deposition (CVD) is an example of vacuum deposition and refers to a process wherein a substrate is exposed to one or more volatile precursors, which react and/or decompose on the substrate surface to produce a layer. Examples of CVD include low pressure chemical vapour deposition (LPCVD) and plasma enhanced chemical vapour deposition (PECVD).

In examples, the depositing comprises electrophoretic depositing. Electrophoretic deposition refers to a process wherein colloidal particles suspended in a liquid medium migrate under the influence of an electric field (electrophoresis) and are deposited onto a substrate. Examples of electrophoretic deposition include electrocoating, electrodeposition, and electrophoretic coating, and electrophoretic painting.

In examples, the depositing comprises casting. Examples of casting include spray casting, sheet casting, and spin casting.

In examples, the providing the cathode layer and the providing the ceramic layer comprise providing a cathode-ceramic laminate comprising the cathode layer and the ceramic layer. The ceramic layer typically abuts the cathode layer. In examples, providing the cathode-ceramic laminate comprises providing a cathode layer, and depositing ceramic on the cathode layer, thereby providing the ceramic layer on the cathode layer. The ceramic may be deposited according to any of the methods described hereinabove. In examples, the ceramic is deposited via vacuum deposition such as PVD or CVD. In examples, the ceramic is LiPON.

In examples, providing the cathode layer comprises depositing cathode-layer material on a current collector (e.g. providing a current collector, and coating the current collector with cathode-layer material). A cathode-layer material is any material which functions as a cathode, or a material which can be treated to provide a material which functions as a cathode. A cathode-layer material which is treated to provide a material which functions as a cathode may also be referred to as a cathode precursor.

In examples, the cathode-layer material comprises any of the materials described hereinabove in relation to the cathode layer of the electrochemical cell, and/or precursors to said materials.

In examples, providing the anode layer comprises depositing anode-layer material on a current collector. The current collector on which the anode-layer material is deposited is separate from the current collector on which the cathode-layer material is deposited in examples. An anode-layer material is any material which functions as an anode, or a material which can be treated to provide a material which functions as an anode. An anode-layer material which is treated to provide a material which functions as an anode is also be referred to as an anode precursor.

In examples, the anode-layer material comprises any of the materials described hereinabove in relation to the anode layer, or precursors to said materials. Suitably, the anode-layer material is one which undergoes a formation charge to plate lithium to the anode-layer material.

In examples, the anode-layer material is lithium metal, and the depositing the lithium metal on the current collector provides a lithium metal film. Typically, lithium metal is deposited on the current collector via thermal deposition.

The lithium metal sheet may undergo a cooling process after its thermal deposition on the current collector. For example, the lithium metal film undergoes laser ablation. In other examples, the lithium metal sheet does not undergo a cooling process. For example, the lithium metal film does not undergo laser ablation. The present inventors have identified that the laser ablation process is optional in this example because it is not necessary to cool the lithium metal sheet layer before continuing with the method. Obviating the need for this process simplifies the manufacturing method such that the method may be quicker, simpler, and more cost-efficient.

The polymer electrolyte is deposited on the ceramic layer and/or the anode layer. In examples, the polymer electrolyte layer is deposited on the anode layer to provide an anode-electrolyte laminate comprising an anode layer and an electrolyte layer. In examples, the polymer electrolyte is deposited on the ceramic layer to provide a polymer electrolyte layer on the ceramic layer. For example, the cathode layer and ceramic layer are provided as a cathode-ceramic laminate, and the polymer electrolyte layer is deposited on the ceramic layer to provide a cathode-ceramic-electrolyte laminate comprising a cathode layer, a ceramic layer, and an electrolyte layer.

The method includes combining the cathode layer, ceramic layer (optionally as a cathode-ceramic laminate), anode layer and polymer electrolyte layer to provide an electrochemical cell wherein the ceramic layer is arranged between the cathode layer and the anode layer, and the polymer electrolyte layer is arranged between the ceramic layer and the anode layer. Typically, the polymer electrolyte layer abuts the anode layer and/or the ceramic layer.

Where the polymer layer has been deposited on the anode layer to provide an anode-electrolyte laminate, in examples the combining comprises aligning and lamination of the cathode layer and ceramic layer (e.g as a cathode-ceramic laminate) with the anode-electrolyte laminate to provide the electrochemical cell.

In examples, the combining comprises aligning and lamination of the cathodelayer, ceramic layer, and electrolyte layer with the anode layer to provide the electrochemical cell. For example, where the polymer layer has been deposited on a cathode-ceramic laminate to provide a cathode-ceramic-electrolyte laminate, the combining comprises aligning and lamination of the cathode-ceramic-electrolyte laminate with the anode layer to provide the electrochemical cell.

Such alignment and lamination is achieved by any suitable method. For example, the combining may comprise hot rolling and/or hot pressing.

In examples, the providing the anode, and the combining the cathode layer, ceramic layer (e.g. as a cathode-ceramic laminate), anode layer and polymer electrolyte layer to provide an electrochemical cell, is performed simultaneously. For example, where polymer electrolyte has been deposited on the ceramic layer of a cathode-ceramic laminate to provide a cathode-ceramic-electrolyte laminate, the polymer electrolyte layer being a solid polymer electrolyte layer, the method comprises depositing lithium metal on the solid polymer electrolyte layer, thereby simultaneously providing an anode layer and combining the components of the electrochemical cell recited hereinabove to provide the electrochemical cell. The method may further include depositing a current collector on the anode layer. In examples, the anode layer is a lithium metal anode, and the method includes depositing a current collector on the anode. In examples, the anode layer is not a lithium metal anode, and the method does not include depositing a current collector on the anode.

In examples, the polymer electrolyte is a gel polymer electrolyte and the polymer electrolyte layer is a gel polymer electrolyte layer.

In some examples, depositing the gel polymer electrolyte comprises depositing a polymer film on the ceramic layer. Depositing the polymer film comprises vacuum deposition and/or electrophoretic deposition of polymer, for example. The polymer is typically selected to have a suitable dielectric constant (κ). In examples, the polymer has a dielectric constant less than or equal to 10, or less than or equal to 6. In some examples, the polymer has a dielectric constant of approximately 1. Suitable polymer films comprise PPO, PEO, MAN/PMMA and/or PVDF, for example. The polymer film typically has a thickness of less than 10 micrometres (μm).

In these examples the depositing also comprises supplying a lithium salt solution to the polymer film. In examples, the lithium salt comprises LiO₄Cl, LiTFSI, and/or LiPF₆. The lithium salt is provided in a solvent, typically an organic solvent. The solvent is any suitable solvent, and is typically selected so that it sufficiently wets the polymer film (e.g. forms a contact angle θ with the polymer film of 0<θ<90°).

The material deposited to form the polymer electrolyte layer may undergo crosslinking. In examples, said crosslinking is initiated upon application of heat, ultraviolet (UV) radiation, and/or infrared (IR) radiation.

In other examples, depositing the gel polymer electrolyte comprises casting a mixture comprising polymer, lithium salt and solvent on the ceramic layer, and crosslinking the mixture, thereby providing the gel polymer electrolyte layer.

Again, the polymer is typically selected to have a suitable dielectric constant. In examples, the polymer has a dielectric constant (Fr) less than or equal to 10, or less than or equal to 6. In some examples, the polymer has a dielectric constant of approximately 1. Suitable polymers comprise PPO, PEO, MAN/PMMA and/or PVDF, for example; suitable lithium salts comprise LiO₄Cl, LiTFSI, and/or LiPF₆, for example. The mixture typically undergoes crosslinking to form a polymer electrolyte matrix, initiated upon application of heat, UV radiation and/or IR radiation, for example. The mixture cast on the ceramic layer typically forms a layer having a thickness of approximately 10 μm.

In examples, the polymer electrolyte is a solid polymer electrolyte and the polymer electrolyte layer is a solid polymer electrolyte layer.

In some examples, depositing the solid polymer electrolyte comprises depositing a polymer film on the ceramic layer or the anode layer via vacuum deposition of polymer, for example. The polymer is typically selected for its dielectric strength. Suitable polymer films comprise PPO, PEO, MAN/PMMA and/or PVDF, for example. The polymer film typically has a thickness of less than 1 μm.

In these examples, the depositing also comprises supplying a lithium salt solution to the polymer film. In examples, the lithium salt comprises LiO₄Cl and/or LiTFSI. The lithium salt is provided in a solvent, typically a volatile solvent. Employing a volatile solvent may reduce the evaporative load in any subsequent drying/evaporative process.

In these examples, the volatile solvent is evaporated from the system, thereby providing the solid polymer electrolyte layer. The volatile solvent is suitably removed by vacuum drying.

In other examples, depositing the solid polymer electrolyte comprises depositing a polymer film on the anode layer via electrodeposition of polymer, for example. The mixture used in the electrodeposition of the layer typically comprises polymer and lithium salt. Suitable polymer films comprise PPO, PEO, MAN/PMMA and/or PVDF, for example; suitable lithium salts comprise LiO₄Cl and/or LiTFSI, for example. The polymer film typically has a thickness of less than 1 μm.

In these examples, it is unnecessary to supply a lithium salt solution to the polymer film, as the ionic conductors are provided to the electrolyte layer via the electrodeposition process. It is further unnecessary to remove solvent form the polymer layer via a drying process.

In examples, once the cathode layer, ceramic layer, anode layer and polymer electrolyte layer have been combined to provide the laminate electrochemical cell, the method further comprises winding the laminate electrochemical cell to provide a wound laminate electrochemical cell.

For example, the laminate electrochemical cell is round wound to provide a wound laminate electrochemical cell suitable for a cylindrical cell case, or the laminate electrochemical cell is flat wound to provide a wound laminate electrochemical cell suitable for a prismatic cell case.

According to a further aspect of the present disclosure there is provided an electrochemical cell obtainable by examples of methods as described herein.

According to examples of a yet further aspect of the present disclosure there is provided a battery stack comprising a plurality of laminate electrochemical cells, each cell comprising: a first current collector;
a cathode layer arranged on a surface of the first current collector;
a second current collector;
an anode layer arranged on a surface of the second current collector;
a polymer electrolyte layer arranged between the cathode layer and the anode layer, the polymer electrolyte layer coating at least a portion of the anode layer; and
a ceramic layer arranged between the polymer electrolyte layer and the cathode layer;
wherein the ceramic layer and the polymer electrolyte layer have different compositions.

The plurality of cells may suitably comprise 2, 3, 4, 5, or more than 5 electrochemical cells. Said battery stack typically comprises a plurality of electrochemical cells as described herein.

In examples, the battery stack is a “back-to-back” stack. For example, the cathodes of two cells are arranged to contact a single current collector. Accordingly, in examples wherein the plurality of electrochemical cells comprises a first electrochemical cell and a second electrochemical cell, the first current collector of the first cell is also the first current collector of the second cell.

In examples, the cathode of each cell comprises material typically used in solid-state battery cells. Where the battery stack is a “back-to-back” stack, the cathodes and first current collector of the first and second electrochemical cells represent a solid-state electrode.

In examples, the anode of each cell comprises material typically used in conventional lithium-ion batteries. For example, the anode of each cell comprises silicon, carbon (optionally as graphite, graphene, activated carbon and/or carbon black), indium tin oxide (ITO), molybdenum dioxide (MoO₂), lithium titanate (Li₂TiO₃), lithium alloy, metallic lithium, copper, or combinations thereof. Said materials may suitably be lithium-intercalated, to the extent that it is technically achievable. Where the battery stack is a “back-to-back” stack, the anodes and second current collectors of the first and second electrochemical cells represent a conventional electrode.

In examples, the cathode of each cell comprises material typically used in solid-state battery cells, and the anode of each comprises material typically used in conventional lithium-ion batteries. Such a battery stack may benefit from the increased safety and energy density associated with solid-state batteries, as well as the cost-effectiveness and ease of manufacturing associated with typical liquid-electrolyte-containing batteries.

Methods of manufacturing said battery stacks also form part of the present disclosure. Said methods typically correspond to those described herein in relation to manufacture of a cell, wherein the process is repeated to build a plurality of laminate cells arranged in a laminate stack structure.

In examples, the method comprises manufacturing a laminate structure comprising a cathode layer on a current collector, a ceramic layer, a polymer electrolyte layer, and an anode on a current collector, separating the structures into individual cells and folding the laminate structure in a ‘concertina’ or zig-zag fashion, thereby providing a battery stack of cells in which every other cell in the stack is reversed so that each current collector has either an anode on each opposing face or a cathode on each opposing face. In examples, the battery stack of cells is provided in a pouch cell, e.g a stacked pouch cell.

In examples of a yet further aspect of the present disclosure there is provided an electrically-powered device comprising the electrochemical cell described herein, or the battery stack described herein. An electrically-powered device is any apparatus which draws electric power from a circuit which includes the cell or battery stack, converting the electric power from the cell or battery stack to other forms of energy such as mechanical work, heat, light, and so on. In examples, the electrically-powered device is a smartphone, a cell phone, a personal digital assistant, a radio player, a music player, a video camera, a tablet computer, a laptop computer, military communications, military lighting, military imaging, a satellite, an aeroplane, a micro air vehicle, a hybrid electric vehicle, a plug-in hybrid electric vehicle, a fully electric vehicle, an electric scooter, an underwater vehicle, a boat, a ship, an electric garden tractor, an unmanned aero drone, an unmanned aeroplane, an RC car, a robotic toy, a vacuum cleaner such as a robotic vacuum cleaner, a robotic garden tool, a robotic construction utility, a robotic alert system, a robotic aging care unit, a robotic kid care unit, an electric drill, an electric mower, an electric vacuum cleaner, an electric metal working grinder, an electric heat gun, an electric press expansion tool, an electric saw or cutter, an electric sander and polisher, an electric shear and nibbler, an electric router, an electric tooth brush, an electric hair dryer, an electric hand dryer, a global positioning system (GPS) device, a laser rangefinder, a torch (flashlight), an electric street lighting, a standby power supply, uninterrupted power supplies, or another portable or stationary electronic device.

Features described herein in relation to one aspect of the present disclosure are explicitly disclosed in combination with the other aspects, to the extent that they are compatible.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a schematic diagram of a cross-section of an electrochemical cell according to examples.

FIG. 2 is a schematic diagram of a cross-section of a battery stack according to examples.

FIG. 3 is a flow chart of a method according to examples.

FIG. 4 is a schematic flow diagram of a method according to examples, depicting cross-sections of an electrochemical cell and component portions of the electrochemical cell at points in the method.

FIG. 5 is a schematic flow diagram of a method according to examples, depicting cross-sections of an electrochemical cell and component portions of the electrochemical cell at points in the method.

FIG. 6 is a schematic flow diagram of a method according to an example, depicting cross-sections of an electrochemical cell and component portions of the electrochemical cell at points in the method.

### DETAILED DESCRIPTION

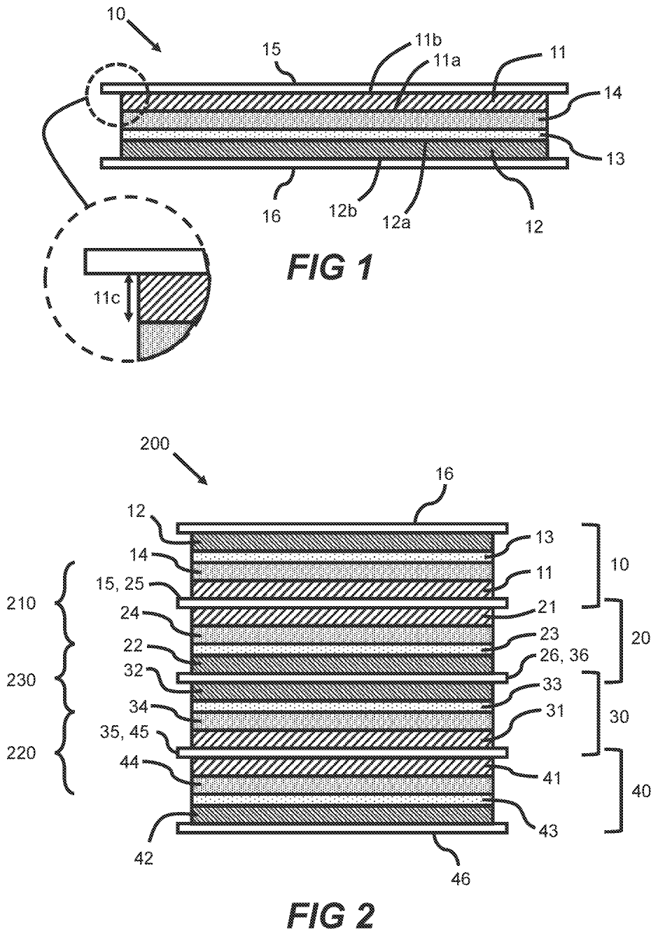

FIG. 1 shows a cross-section of one example of an electrochemical cell 10 according to examples. The cell 10 comprises a cathode 11, an anode 12, a polymer electrolyte layer 13, and a ceramic layer 14. The cell 10 typically comprises current collectors 15, 16.

The polymer electrolyte layer 13 juxtaposes the anode 12 as a polymer electrolyte coating. The polymer electrolyte layer 13 contacts a first surface 12a of the anode layer.

The ceramic layer 14 juxtaposes the polymer electrolyte layer 13. The polymer electrolyte layer 13 and the ceramic layer 14 are different, discrete layers having different compositions.

The cathode layer 11 juxtaposes the ceramic layer 14. The ceramic layer contacts a first surface 11a of the cathode layer 11.

The cathode layer 11 of the cell 10 comprises materials typically employed in solid-state battery cells. The anode layer 12 of the cell 10 comprises materials typically employed in conventional Li-ion electrochemical cells.

The first current collector 15 is arranged on a second surface 11b of the cathode 11, the second surface 11b being opposite to the interface between the cathode 11 and the ceramic layer 14 at the first surface 11a of the cathode 11. The second current collector 16 is arranged on a second surface 12b of the anode 12, the second surface 12b being opposite to the interface between the anode 12 and the polymer electrolyte layer 13 at the first surface 12a of the anode 12. The current collectors 15, 16 comprise a metal layer.

FIG. 2 shows a cross-section of one example of a battery stack 200 comprising a plurality of electrochemical cells 10, 20, 30, 40. As shown in FIG. 2, the plurality comprises a first cell 10, a second cell 20, a third cell 30, and a fourth cell 40. Other examples of battery stack 200 need only in fact comprise at least two electrochemical cells; and, the number of cells shown in FIG. 2 is purely exemplary. The description and teaching regarding FIG. 2 is also explicitly disclosed in relation to any battery stack comprising any number of electrochemical cells according to the present disclosure, to the extent that said teaching and said battery stack are technically compatible.

Each cell 10, 20, 30, 40 corresponds to the cell 10 shown in FIG. 1. The components of each cell 10, 20, 30, 40 are labelled such that the second digit corresponds to that used in FIG. 1 to indicate where components are equivalent, and the first digit corresponds to the first digit of the cell of which it is comprised.

The battery stack 200 is a “back-to-back” stack, in which every other cell in the stack is reversed so that each current collector has either an anode on each opposing face or a cathode on each opposing face. In particular, in FIG. 2, the cathode 11 of the first cell 10 and the cathode 21 of the second cell 20 are arranged on opposite faces of a current collector 15/25. The current collector 15/25 comprises an outer metal foil surface and a core having lower electrical conductivity than the outer metal foil surface, and thus is configured to form an electrode on both faces of the layer, e.g. the first current collector 15 of the first cell 10 and the first current collector 25 of the second cell 20. Thus, the first current collector 15 of the first cell 10 is the first current collector 25 of the second cell. The same applies to the first current collector 35 of the third cell 30 and the first current collector 45 of the fourth cell 40 mutatis mutandis.

The anode 22 of the second cell 20 and the anode 32 of the third cell 30 are arranged on opposite faces of a current collector 26/36. The current collector 26/36 comprises an outer metal foil surface and a core having lower electrical conductivity than the outer metal foil surface, and thus is configured to form an electrode on both faces of the layer, e.g. the second current collector 26 of the second cell 20 and the second current collector 36 of the third cell 30. Although not shown in FIG. 2, the same applies to the anode 12 and the second current collector 16 of the first cell 10 mutatis mutandis, and to the anode 42 and the second current collector 46 of the fourth cell mutatis mutandis, if further electrochemical cells are comprised in the battery stack 200.

The cathode 11, 21, 31, 41 of each cell 10, 20, 30, 40 comprises material typically employed in solid-state battery cells. Thus, taken together, the cathodes 11, 21, first current collector 15, 25, and ceramic layers 14, 24 of the first and second cells 10, 20 form a solid-state electrode 210. In the same way, taken together, the cathodes 31, 41, first current collector 15, 25, and ceramic layers 14, 24 of the third and fourth cells 30, 40 form a solid-state electrode 220.

In a first example of the battery stack 200, the polymer electrolyte layers 13, 23, 33, 43 are gel polymer electrolyte layers. In this first example, the anodes 12, 22, 32, 42 comprise material typically employed in conventional Li-ion electrochemical cells. Thus, taken together, the anodes 22, 32, and second current collector 26, 36 of the second and third cells 20, 30 form a conventional electrode 230.

In a second example of the battery stack 200, the polymer electrolyte layers 13, 23, 33, 43 are solid polymer electrolyte layers. In this second example, the anodes 12, 22, 32, 42 comprise material typically employed in conventional solid-state battery cells. Thus, taken together, the anodes 22, 32, and second current collector 26, 36 of the second and third cells 20, 30 form a solid-state electrode 230.

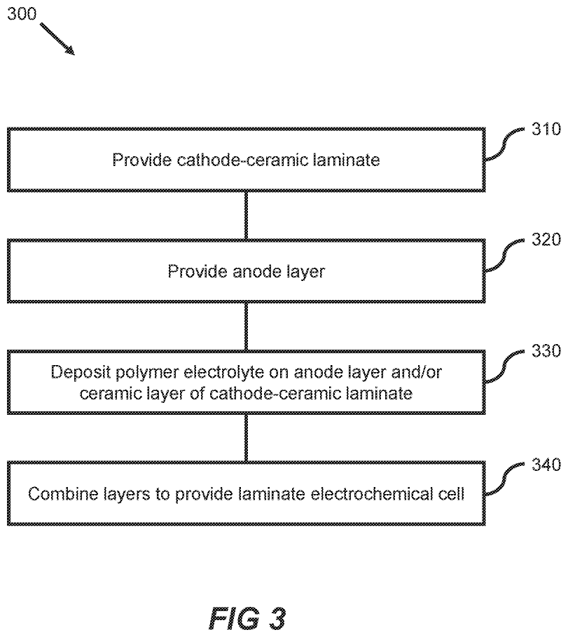

FIG. 3 is a flow chart depicting a method 300 of manufacturing an electrochemical cell according to examples. The method 300 comprises providing 310 a cathode-ceramic laminate comprising a cathode layer and a ceramic layer. Providing 310 the cathode-ceramic laminate comprises any suitable process as described herein.

The method 300 comprises providing 320 an anode layer. Providing 320 the anode layer comprises any suitable process described herein.

The method 300 comprises depositing 330 a polymer electrolyte on the anode layer and/or the ceramic layer to provide a polymer electrolyte layer. The depositing 330 comprises any suitable process described herein.

The method 300 comprises combining the cathode-ceramic laminate, anode layer and polymer electrolyte layer to provide 340 the laminate battery cell 340. These items are combined such that the polymer electrolyte layer is arranged between the ceramic layer and the anode layer. The combining 340 comprises any suitable process described herein.

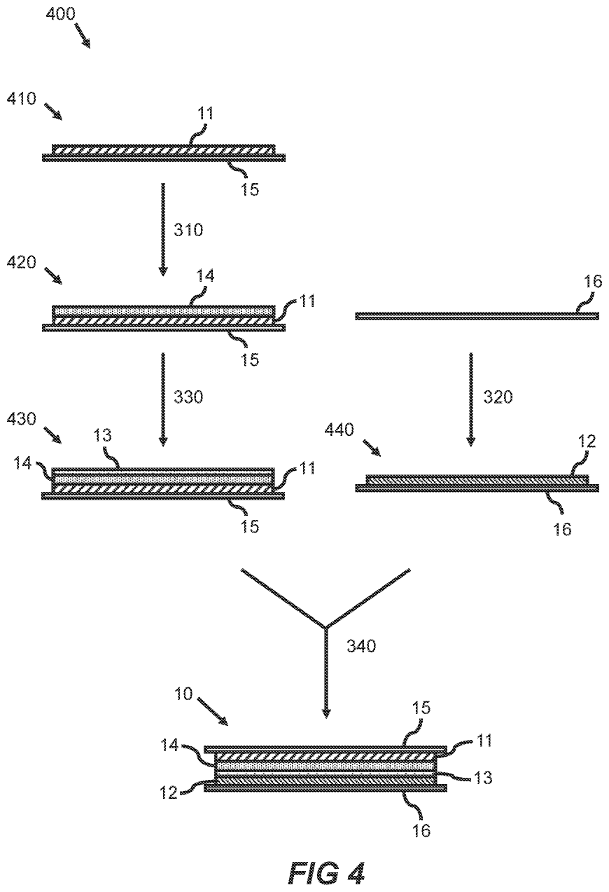

FIG. 4 is a flow diagram illustrating schematically a method 400 according to two examples of the method 300 depicted in FIG. 3 (a first example, and a second example). FIG. 4 shows cross-sections of an electrochemical cell 10 and component portions of the electrochemical cell 10 at points in the method 400. Where aspects of FIG. 4 correspond to features or method blocks depicted in previously-described figures, the same reference numbers are employed to aid understanding only. For the avoidance of doubt, limitations or requirements described in respect of the previously-described figures do not apply to the method 400 depicted in FIG. 4, and vice versa.

In the first and second examples, the method 400 comprises providing a cathode layer 11. The cathode layer is provided on a current collector 15 as a cathode laminate 410.

In the first and second examples, the method 400 further comprises depositing 310 ceramic on the cathode layer 11, thereby providing a ceramic layer 14 on the cathode layer 11. The ceramic is deposited via vacuum deposition such as PVD or CVD. Together, the current collector 15, cathode 11 and ceramic layer 14 form a cathode-ceramic laminate 420.

In the first and second examples, the method further comprises depositing 330 polymer electrolyte on the ceramic layer 14 to form a polymer electrolyte layer 13. The polymer electrolyte is a gel polymer electrolyte, and the polymer electrolyte layer 13 is a gel polymer electrolyte layer. Together, the cathode-ceramic laminate 420 and the gel polymer electrolyte layer form a cathode-ceramic-electrolyte laminate 430.

In the first example depicted by FIG. 4, the depositing 330 the electrolyte comprises depositing a polymer film on the ceramic layer. Depositing the polymer film comprises vacuum deposition and/or electrophoretic deposition of polymer. The polymer film comprises PPO, PEO, MAN/PMMA and/or PVDF. The polymer film has a thickness of less than 10 μm.

The depositing 330 also comprises supplying a lithium salt solution to the polymer film. The lithium salt comprises LiO₄Cl, LiTFSI, and/or LiPF₆. The lithium salt is provided in an organic solvent. The solvent, when deposited on the polymer film, forms a contact angle θ with the polymer film of 0<θ<90°.

The material deposited to form the polymer electrolyte layer optionally undergoes crosslinking. Said crosslinking is initiated upon application of heat, ultraviolet (UV) radiation, and/or infrared (IR) radiation.

In the second example depicted by FIG. 4, the depositing 330 the gel polymer electrolyte comprises casting a mixture comprising polymer, lithium salt and solvent on the ceramic layer, and crosslinking the mixture, thereby providing the gel polymer electrolyte layer.

The mixture comprises PPO, PEO, MAN/PMMA and/or PVDF, and LiO₄Cl, LiTFSI, and/or LiPF₆. The crosslinking comprises applying heat, UV radiation and/or IR radiation to the mixture. The mixture cast on the ceramic layer 14 forms a layer 13 having a thickness of approximately 10 μm.

In the first and second examples, the method 400 comprises providing 320 an anode layer 12. Providing 320 the anode layer 12 comprises depositing lithium metal on a current collector 16 to provide a lithium metal film via thermal deposition. The anode layer 12 and current collector 16 together form an anode laminate 440.

In the first and second examples, the method 400 comprises combining 340 the layers to form an electrochemical cell 10. In the example depicted, the combining 340 comprises aligning the anode laminate 440 on the cathode-ceramic-electrolyte laminate 430, and hot rolling or pressing the laminates 340 to provide the cell 10.

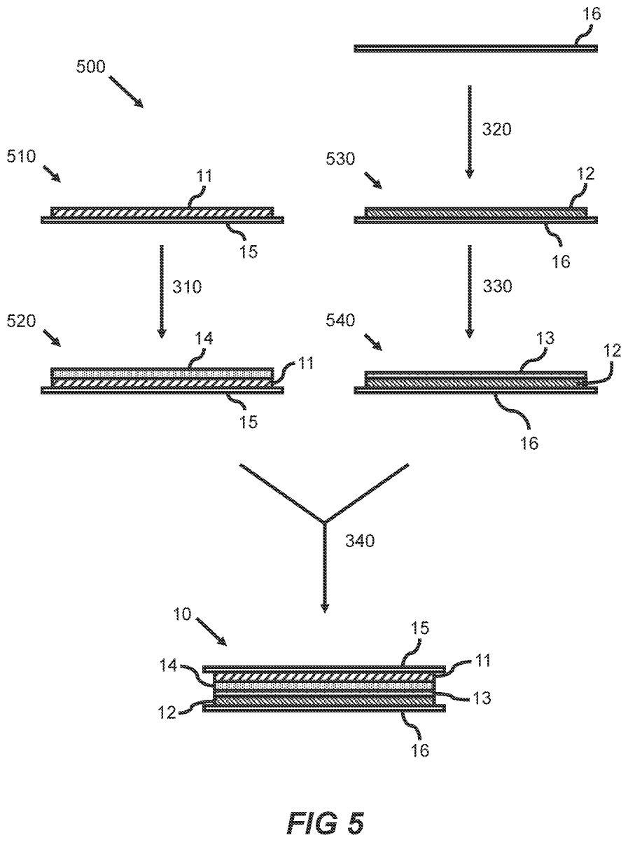

FIG. 5 is a flow diagram illustrating schematically a method 500 according to two examples of the method 300 depicted in FIG. 3 (a first example, and a second example). FIG. 4 shows cross-sections of an electrochemical cell 10 and component portions of the electrochemical cell 10 at points in the method 500. Where aspects of FIG. 5 correspond to features or method blocks depicted in previously-described figures, the same reference numbers are employed to aid understanding only. For the avoidance of doubt, limitations or requirements described in respect of the previously-described figures do not apply to the method 500 depicted in FIG. 5, and vice versa.

In the first and second examples, the method 500 comprises providing a cathode layer 11. The cathode layer is provided on a current collector 15 as a cathode laminate 510.

In the first and second examples, the method 500 further comprises depositing 310 ceramic on the cathode layer 11, thereby providing a ceramic layer 14 on the cathode layer 11. The ceramic is deposited via vacuum deposition such as PVD or CVD. Together, the current collector 15, cathode 11 and ceramic layer 14 form a cathode-ceramic laminate 520.

In the first and second examples, the method 500 comprises providing 320 an anode layer 12. Providing 320 the anode layer 12 comprises depositing lithium metal on a current collector 16 to provide a lithium metal film via thermal deposition. The anode layer 12 and current collector 16 together form an anode laminate 530.

In the first and second examples, the method further comprises depositing 330 polymer electrolyte on the anode layer 12 to form a polymer electrolyte layer 13. The polymer electrolyte is a solid polymer electrolyte, and the polymer electrolyte layer 13 is a solid polymer electrolyte layer. Together, the anode laminate 530 and the solid polymer electrolyte layer form an anode-electrolyte laminate 540.

In the first example depicted by FIG. 5, depositing 330 the solid polymer electrolyte comprises depositing a polymer film on the anode layer 12 via vacuum deposition of polymer.

The polymer comprises PPO, PEO, MAN/PMMA and/or PVDF. The polymer film has a thickness of less than 1 μm.

The depositing also comprises supplying a lithium salt solution to the polymer film, the solution comprising lithium salt comprising LiO₄Cl and/or LiTFSI, and a volatile solvent.

The depositing also comprises evaporating the volatile solvent via vacuum drying, thereby providing the solid polymer electrolyte layer 13.

In the second example depicted by FIG. 5, depositing 330 the solid polymer electrolyte comprises depositing a polymer film on the anode layer via electrodeposition of polymer. The mixture used in the electrodeposition of the layer comprises polymer (PPO, PEO, MAN/PMMA and/or PVDF) and lithium salt (LiO₄Cl and/or LiTFSI). The polymer film has a thickness of less than 1 μm.

In the first and second examples, the method 500 comprises combining 340 the layers to form an electrochemical cell 10. In the example depicted, the combining 340 comprises aligning the anode-electrolyte laminate 540 on the cathode-ceramic laminate 520, and hot rolling or pressing the laminates 340 to provide the cell 10.

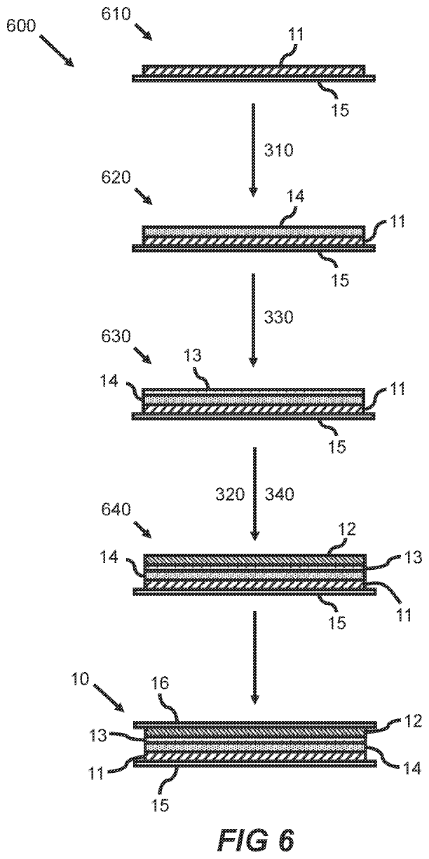

FIG. 6 is a flow diagram illustrating schematically a method 600 according to an example of the method 300 depicted in FIG. 3. FIG. 6 shows cross-sections of an electrochemical cell 10 and component portions of the electrochemical cell 10 at points in the method 600. Where aspects of FIG. 6 correspond to features or method blocks depicted in previously-described figures, the same reference numbers are employed to aid understanding only. For the avoidance of doubt, limitations or requirements described in respect of the previously-described figures do not apply to the method 600 depicted in FIG. 6, and vice versa.

Method 600 comprises providing a cathode layer 11. The cathode layer is provided on a current collector 15 as a cathode laminate 610.

The method 600 further comprises depositing 310 ceramic on the cathode layer 11, thereby providing a ceramic layer 14 on the cathode layer 11. The ceramic is deposited via vacuum deposition such as PVD or CVD. Together, the current collector 15, cathode 11 and ceramic layer 14 form a cathode-ceramic laminate 620.

The method 600 further comprises depositing 330 polymer electrolyte on the ceramic layer 14 to form a polymer electrolyte layer 13. The polymer electrolyte is a solid polymer electrolyte, and the polymer electrolyte layer 13 is a solid polymer electrolyte layer. Together, the cathode-ceramic laminate 620 and the gel polymer electrolyte layer form a cathode-ceramic-electrolyte laminate 630.

Depositing 330 the solid polymer electrolyte comprises depositing a polymer film on the ceramic layer 12 via vacuum deposition of polymer. The polymer comprises PPO, PEO, MAN/PMMA and/or PVDF. The polymer film has a thickness of less than 1 μm.

The depositing 330 also comprises supplying a lithium salt solution to the polymer film, the solution comprising lithium salt comprising LiO₄Cl and/or LiTFSI, and a volatile solvent.

The depositing 330 also comprises evaporating the volatile solvent via vacuum drying, thereby providing the solid polymer electrolyte layer 13.

The method 600 further comprises simultaneously providing 320 the anode 12 and combining 340 the cathode-ceramic laminate 620, anode layer 12 and polymer electrolyte layer 13 to provide an electrochemical cell 640. Performing these acts 320, 340 simultaneously comprises depositing lithium metal on the solid polymer electrolyte layer 13 via thermal deposition.

The method 600 further comprises depositing a current collector 16 on the anode layer 12 to provide an electrochemical cell 10 comprising a cathode 11, an anode 12, a polymer electrolyte layer 13, and a ceramic layer 14. The cell 10 typically comprises current collectors 15, 16.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1: A laminate electrochemical cell comprising:
a cathode layer;
an anode layer;
a polymer electrolyte layer arranged between the cathode layer and the anode layer, the polymer electrolyte layer coating at least a portion of the anode layer; and
a ceramic layer arranged between the polymer electrolyte layer and the cathode layer;
wherein the ceramic layer and the polymer electrolyte layer have different compositions.

2: The laminate cell according to claim 1, wherein the polymer electrolyte layer comprises solid polymer electrolyte.

3: The laminate cell according to claim 1, wherein the polymer electrolyte layer is non-porous.

4: The laminate cell according to claim 1, wherein the polymer electrolyte layer comprises gel polymer electrolyte.

5: The laminate cell according to claim 1, wherein the ceramic layer comprises lithium phosphorous oxy-nitride (LiPON).

6: The laminate cell according to claim 1, wherein the ceramic layer is porous.

7: The laminate electrochemical cell according to claim 1, wherein the cathode comprises lithium cobalt oxide (LiCoO₂), lithium manganese oxide (LiMn₂O₄), lithium nickel manganese cobalt oxide (LiNiMnCoO₂), lithium iron phosphate (LiFePO₄), lithium nickel cobalt aluminium oxide (LiNiCoAlO₂), lithium titanate (Li₂TiO₃), or combinations thereof.

8: The laminate electrochemical cell according to claim 1, wherein the anode comprises silicon, carbon (optionally as graphite, graphene, activated carbon and/or carbon black), indium tin oxide (ITO), molybdenum dioxide (MoO₂), lithium titanate (Li₂TiO₃), lithium alloy, metallic lithium, copper, or combinations thereof.

9: The laminate electrochemical cell according to claim 1, wherein the anode comprises a lithium-intercalated material.

10: The electrochemical cell according to claim 1, wherein at least one of the layers has a thickness greater than or equal to 1 μm.

11: The electrochemical cell according to claim 1, wherein each of the layers has a thickness greater than or equal to 0.2 μm.

12: A method of manufacturing a laminate electrochemical cell, the method comprising:
providing a cathode layer;
providing a ceramic layer;
providing an anode layer;
depositing a polymer electrolyte on the anode layer and/or the ceramic layer to provide a polymer electrolyte layer; and
combining the cathode layer, ceramic layer, anode layer and polymer electrolyte layer to provide the laminate electrochemical cell such that the ceramic layer is arranged between the cathode layer and the anode layer, and the polymer electrolyte layer is arranged between the ceramic layer and the anode layer.

13: The method according to claim 12, wherein the providing the cathode layer and the providing the ceramic layer comprise providing a cathode-ceramic laminate comprising the cathode layer and the ceramic layer.

14: The method according to claim 13, wherein the providing the cathode-ceramic laminate comprises providing a cathode layer, and depositing ceramic on the cathode layer, thereby providing the ceramic layer on the cathode layer.

15: The method according to claim 12, wherein the providing the cathode layer comprises depositing cathode-layer material on a current collector.

16: The method according to claim 12, wherein the providing the anode layer comprises depositing anode-layer material on a current collector.

17: The method according to claim 16, wherein the anode-layer material is lithium metal, and the depositing the lithium metal on the current collector provides a lithium metal film.

18: The method according to claim 17, comprising laser ablating the lithium metal film.

19: The method according to claim 12, wherein the polymer electrolyte is a gel polymer electrolyte and the polymer electrolyte layer is a gel polymer electrolyte layer.

20: The method according to claim 19, wherein the depositing the gel polymer electrolyte comprises depositing a polymer film on the anode layer or ceramic layer, and supplying a lithium salt solution to the polymer film, thereby providing the gel polymer electrolyte layer.

21: The method according to claim 19, wherein the depositing the gel polymer electrolyte comprises casting a mixture comprising polymer, lithium salt and solvent on the anode layer or the ceramic layer, and crosslinking the mixture, thereby providing the gel polymer electrolyte layer.

22: The method according to claim 12, wherein the polymer electrolyte is a solid polymer electrolyte and the polymer electrolyte layer is a solid polymer electrolyte layer.

23: The method according to claim 22, wherein the depositing the polymer electrolyte comprises depositing a polymer film on the anode layer or the ceramic layer, and supplying a solution comprising solvent and lithium salt to the polymer film.

24: The method according to claim 23, wherein the depositing the polymer electrolyte further comprises vacuum drying the polymer film, solvent and lithium salt to provide the solid polymer electrolyte layer.

25: The method according to claim 12, wherein:
the polymer electrolyte is disposed on the ceramic layer to provide the polymer electrolyte layer; and
the providing the anode and the combining are performed simultaneously, comprising thermally depositing lithium metal on the polymer electrolyte layer to provide a lithium metal film, and optionally laser ablating the lithium metal film.

26: The method according to claim 12, wherein:
the polymer electrolyte is deposited on the ceramic layer to provide the polymer electrolyte layer; and
the combining comprises hot rolling or hot pressing the anode layer with the cathode layer, ceramic layer, and electrolyte layer.

27: A battery stack comprising a plurality of laminate electrochemical cells, each cell comprising:
a first current collector;
a cathode layer arranged on a surface of the first current collector;
a second current collector;
an anode layer arranged on a surface of the second current collector;
a polymer electrolyte layer arranged between the cathode layer and the anode layer, the polymer electrolyte layer coating at least a portion of the anode layer; and
a ceramic layer arranged between the polymer electrolyte layer and the cathode layer;
wherein the ceramic layer and the polymer electrolyte layer have different compositions.

28: The battery stack according to claim 27, wherein the plurality of electrochemical cells comprises a first electrochemical cell and a second electrochemical cell, configured such that the first current collector of the first cell is also the first current collector of the second cell.

29: The battery stack according to claim 27, wherein the cathode of each cell comprises material typically used in solid-state battery cells.

30: The battery stack according to claim 27, wherein the anode of each cell comprises silicon, carbon (optionally as graphite, graphene, activated carbon and/or carbon black), indium tin oxide (ITO), molybdenum dioxide (MoO₂), lithium titanate (Li₂TiO₃), lithium alloy, metallic lithium, copper, or combinations thereof.

31: An electrically-powered device comprising the electrochemical cell according to any of claims 1 to 11 or the battery stack according to claim 27.
